(19) United States
(12) Patent Application Publication
(10) Pub. No.: US 2002/0010629 A1
(43) Pub. Date: Jan. 24, 2002

(54) Method and system for electronic anonymous proximity based tracking

(76) Inventor: Andrew Jay Diamond, Marietta, GA (US)

Correspondence Address: Andrew Jay Diamond, 551 Hackney Drive, Marietta, GA, 30067, US

(21) Appl. No.: 09/888,665

(22) Filed: Jun. 25, 2001

Related U.S. Application Data
(60) Provisional application No. 60/220,179, filed on Jul. 24, 2000.

(51) Int. Cl. G06F 17/60

(52) U.S. Cl. 705/14

(57) ABSTRACT

Method and system for electronically tracking the anonymous identity of cellular phones, personal digital assistants, and other carried intelligent devices in a retail environment. The device is recognized as either new or as returning. Customers in a retail environment may actively tag interest in a given item, or passively allow their presence to be noted. When a device is seen returning to the retail store, the customer is given a discount or other reward based upon prior specific interest or volume of prior visitations without regard to prior purchases. A reward is thus delivered for “window shopping.”

### BACKGROUND OF THE INVENTION

Trade occurs in many forms. Retail presence continues to be the preferred conduit for transactions. Except for specialized items that may be difficult to find in any other fashion, purchase of items from catalogs, phone, or the Internet is dwarfed by the transactional volume occurring in retail stores.

A retail store competes with others on price, on presentation, and it's ability to reach potential customers. Reaching potential customers is the role of the advertising industry. Though often expensive, it is rare that word of mouth alone will create the volume necessary to sell most goods. Most companies must rely on recontacting and consistently performing for their existing customers, while advertising to build their customer base.

Unfortunately, it is difficult to measure the effectiveness of most forms of advertising. The advertising is often widely disseminated, and may reach many who for logistical or other pressing reasons could never be potential customers.

It is a true that a retail business must get the customer into the store to create a sale. It is within this time frame the opportunity for revenue occurs. Traditionally, however, the retail establishment is not aware of when a customer enters the establishment. If the retail establishment was aware of an individual's presence, it would have the opportunity to assist the customer.

At the time of checkout and actual purchase, there are already established methods to recognize an individual based on a volunteered phone number, a credit card number, or a checking account number, such as described in U.S. Pat. No. 5,388,165. Based on this information, an establishment could cater to the specific needs and desires of it's customers. Unfortunately, it is not easy to dequeue a customer that has been recognized in order to inform the customer of items that may be of interest to them.

As noted, it is not only advertising that draws customers, but consistent performance that causes repeat interest and purchase. As competition for customers is inevitable, it behooves an establishment to position itself as the premier choice for customers looking for a specific category of goods.

The merging of the aforementioned motivators for the retailer seeking customers requires delivering the right price to the the right individual at the right time. This is the customization of the retail experience.

In order to customize the retail experience, the retailer must deliver personalized attention. Though this can be performed by experienced sales personnel recognizing former and likely future sales candidates, large volume retailers or price leading retailers cannot offer this level of service.

This level of service can be delivered electronically to customers that are appropriately equipped. Wireless devices can be attached to shopping carts, kiosks can be positioned on the floor space, and mobile devices can be given to shoppers such as described in U.S. Pat. No. 5,880,449. Cellular phones and personal digital devices, however, give the best access to individuals. These devices are usually unique to the individual, and likely to be with the individual when the shopper is present.

The cellular phone manufacturers are releasing models that work, sometimes in conjunction with cellular carriers, to allow localization of devices. These are through three general methods, namely triangulation of calls, global positioning systems, and short range radio frequency contact.

Cell phone triangulation is limited by the need for a call to be in progress for the localization to occur. Global positioning systems are limited by their poor or lack of performance when used indoors. Short range radio frequency chips, such as defined by the Bluetooth standard or 802.11b, are less limited in these regards.

Bluetooth and 802.11b short range radio communication devices carried by customers allow communication of timely, appropriate information to the consumer and identification of the consumer. This is the converse of the short range radio communications from labeled items as described in U.S. Pat. No. 6,232,870. Though the devices can uniquely identify individuals by name, this level of contact would be, for many of the consumers, represent an invasion of privacy. Though individuals may opt into such a service, that is not the method and system that is described by this invention. The need fulfilled by this system is to allow systems as described above to offer a financial reward, as discounts and promotions to individuals based upon their pattern of activity as opposed to based upon a named identity. As opposed to systems and methods that reward a shopper for their past activity, such as described in U.S. Pat. No. 5,592,560, location based services allow predictive rewards for activity that a shopper is likely to want. More simply, the system and method describe rewards for anonymous window shopping and visitation.

### BRIEF SUMMARY OF THE INVENTION

A portable computing device, either a cellular phone, personal digital assistants (PDA), or other intelligent device has the ability to communicate with other intelligent devices in its environment. Most portable computing or communication devices are owned and carried by a single individual. If this device is seen multiple times in a retail environment, and the owner is not an employee, this represents a likely customer.

Common computing and communication protocols in a wireless environment require unique identification numbers to coordinate communication. Such numbers exist as telephone numbers for a cellular phone, a unique identifier for Bluetooth devices, or a hardware identifier for an ethernet card. Importantly, these unique identifiers do not disclose the identity of the carrier unless other databases are tapped. In the case of cellular phones, the cellular carriers can identify an individual from phone number. Registration schemes allow PDA's to be similarly identified. However, except in special cases, it is an invasion of privacy, akin to junk mail, to target an individual in a retail environment with unwanted information.

It is not such an invasion of privacy if presence is noted of a device and recorded, given that an individual can turn off devices to make them unavailable for contact. It is also not an invasion of privacy if the holder of a device volitionally communicates a specific desire to the retailer where the retailer does not know the identity of the shopper.

Thus, a shopper that visits regularly can receive a reward, such as a discount, if the device is again present when a purchase is made. The consumer can have a coupon sent to an email address, or to achieve true anonymity, the consumer at the time of purchase have a bar code appear on the computing or communication device to be scanned at the point of sale terminal for the discount.

The consumer could also anonymously relay to a retailer about an interest in an item that the consumer is currently planning on pricing elsewhere. If the consumer returns at a later time or date, the consumer can receive a specific discount for that item, or receive a discount on some associated item. This later creates the opportunity to increase the total value of a transaction. The associated item may be integral in the use of the prime purchase, and if not purchased now, it may be purchase elsewhere, to the detriment of the retailer.

Finally, in a large “big box” store, a short range communication tracking may demonstrate that individuals are not approaching a display the retailers wish to promote. This type of information could also be delivered to a customer interested in a purchase. Again, this demonstrates a capture of a sale that the consumer very well may have made at another retailer, but the opportunity and desire have now been synched. If the desire was there, but the opportunity was lost, the sale may never occur. Other than online transactions, the retailer's only opportunity to sale to the customer is when the customer is present, therefore it is best to make use of the knowledge of the customer's presence.

### BRIEF DESCRIPTION OF DRAWINGS

FIG. 1 is a schematic of the invention.

FIG. 2A is a flowchart demonstrating the flow of events for an unknown new device without consumer input.

FIG. 2B is is a flowchart demonstrating the flow of events for return of a device without consumer input.

FIG. 3A is a flowchart demonstrating the flow of events for an unknown new device with consumer input.

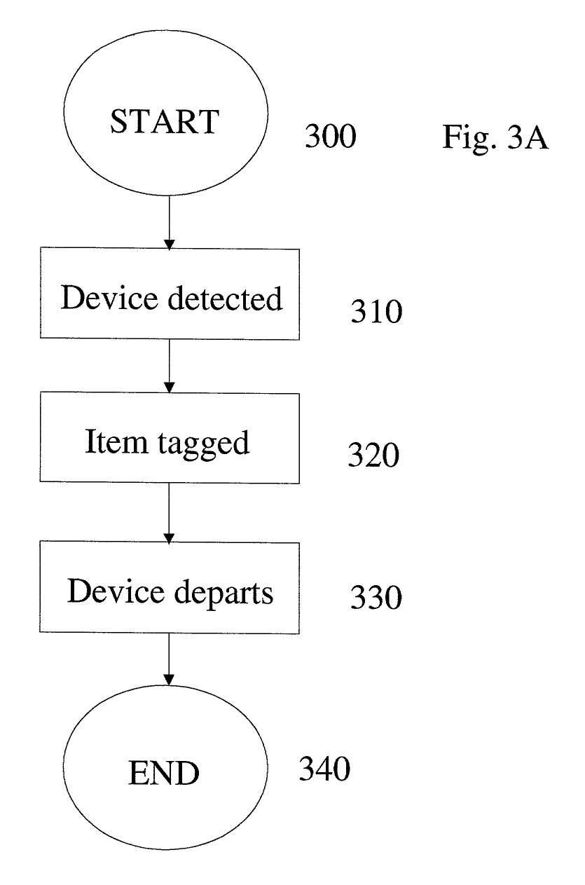

FIG. 3B is is a flowchart demonstrating the flow of events for return of a device with consumer input.

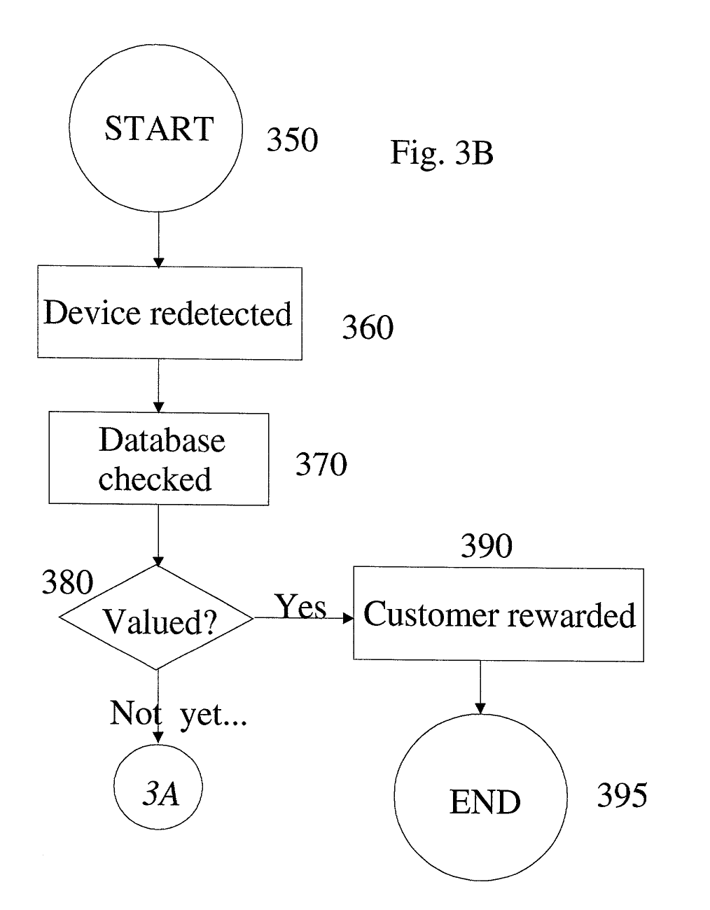

### DETAILED DESCRIPTION

The present invention satisfies the foregoing criteria. Stated generally, the present invention provides a system and method by which a retailer may determine wirelessly the presence and interest of a possible customer while the customer remains anonymous. The system detects commonly carried cellular phones and personal digital assistants that are uniquely identified.

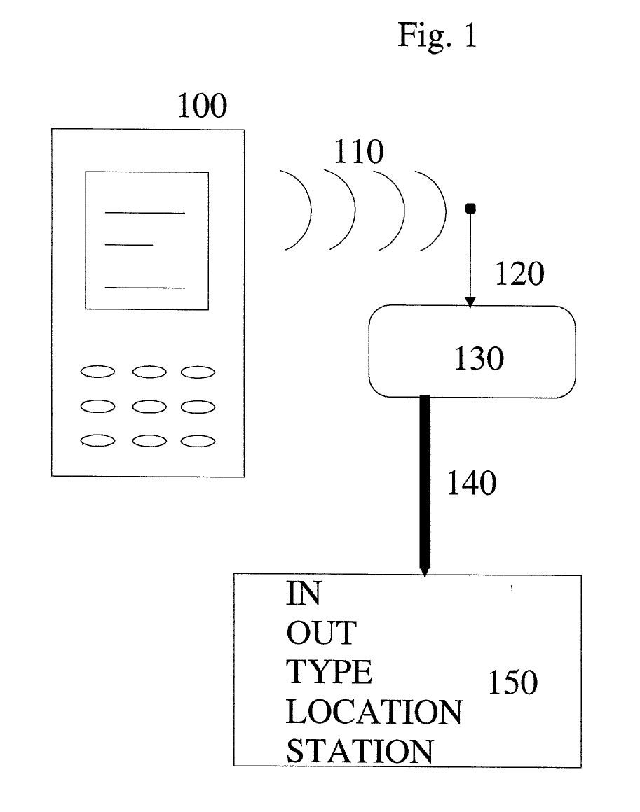

FIG. 1 and the following discussion are intended to provide a brief, general description of a suitable environment in which the invention may be implemented.

With reference to FIG. 1, an exemplary system for implementing the invention includes a cellular phone or personal digital assistant 100 that is capable of wireless transmission 110. The wireless transmission 110 is either via the cellular network or a short range radio communication protocol, such as Bluetooth or 802.11b. The unique identifier of the device is received wirelessly 120 by a detector that may be another Bluetooth, 802.11b, or other protocol capable device 130 that is freestanding or as an accessory to another cellular phone or computing device. If the signal is carried via the cellular packet networks, then the reception 120 would represent the location data captured by the cellular carrier and is delivered 120 either wireless or by hardwire. The data captured by 130 is delivered 140 to a database 150. The database 150 records the identity and characteristics of the device. The database 150 records the entry and exit times of the device.

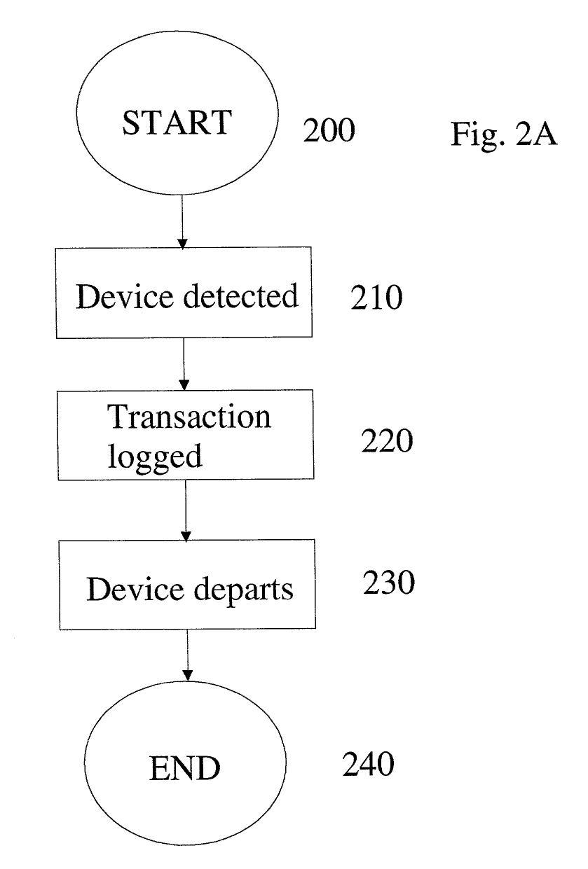

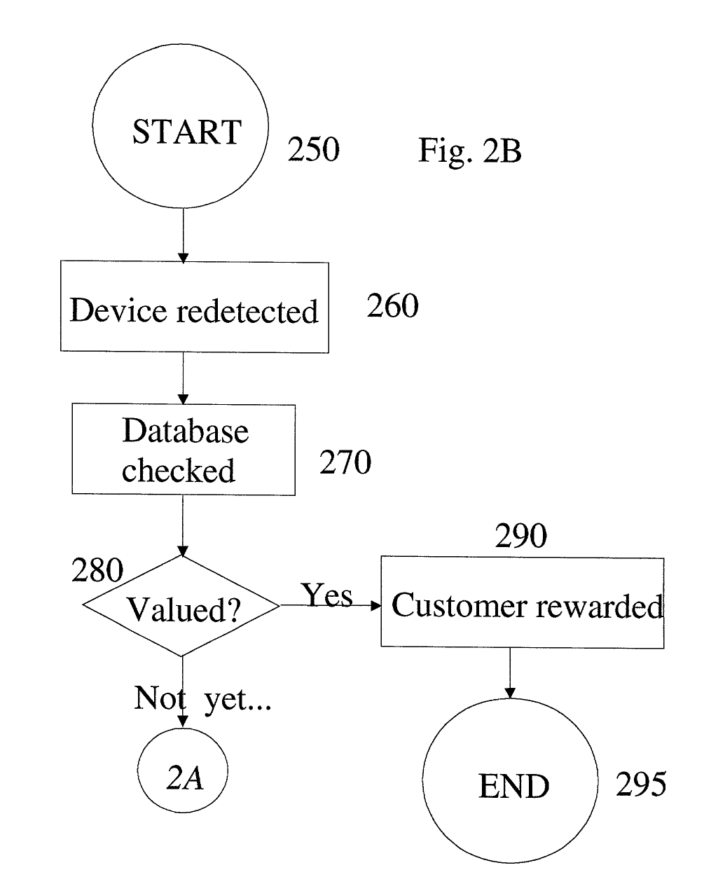

In particular, the database 150 may be used by the retailer to reward consumer activity within the retail space. Accordingly, FIG. 2 is a block diagram illustrating operation of an exemplary embodiment of the present invention with respect to a device 200 entering an establishment on the person of the owner of the device. The device is detected 210 either by entering a zone of reception for a short range wireless protocol, or the device while in use is detected 210 by a cellular carrier which delivers location data to the retailer. The characteristics, identity, and temporal parameters of the device are logged 220 until exit 230 from the zone of observation occurs.

When the device enters 250 in the future, it is subsequently detected 260. The unique identifier for the device is compared against known entries in the database 270 so that a value calculation 280 can be performed based on past sightings. If the characteristics and past behavior of the device are valued enough for a reward 290, it is delivered back to the device or the retailer for use at checkout 295.

A consumer's device 300 may also enter the retailer, be detected 310, but the user may tag interest in an item 320. The item may be described via the portable device by a bar code, description, or a product identification number. The device may then depart 330, but may return 350 in the future. Upon return it is redetected 360 and a database 370 lookup finds location history data as well as the tag data for this device. The prior activity and item interest are used to determine whether a discount for that item or associated items will be offered 380. It is delivered to the device 390 prior to checkout 395.

1. A method for anonymously noting and rewarding the presence of individuals in a retail environment comprising the steps of:
Detecting the cellular phone or other electronic device which is capable of unique identification wirelessly.
Storing the unique identification number and location.
Storing the device' entry time.
Storing the device's exit time.
Checking the device's prior visitations.
Deciding upon a reward based upon visitations
Delivery of the award.

2. A method for anonymous notification by individuals in a retail environment of their specific purchase interests, with subsequent reward for continued interest comprising the steps of:
Detecting the cellular phone or other electronic device which is capable of unique identification wirelessly.
Storing the unique identification number and location.
Storing the device's entry time.
Accepting notification of specific interest by the individual.
Storing the device's exit time.
Detecting a future visitation of the device.
Deciding upon a reward geared towards the specific interest.
Delivery of the award.

3. A computer readable medium having the computer executable instructions for performing the steps recited in claim 1

4. A computer readable medium having the computer executable instructions for performing the steps recited in claim 2

5. A system for anonymously noting and rewarding the presence of individuals in a retail environment comprising:
A detector of cellular phone or other electronic device which is capable of unique identification wirelessly.
A storage for the unique identification number and location.
A storage for the device' entry time.
A storage for the device's exit time.
A comparator of the device's prior visitations.
A computer to calculate a reward based upon visitations.
A transmitter of the award.

6. A system for anonymous notification by individuals in a retail environment of their specific purchase interests, with subsequent reward for continued interest comprising:
A detector for the cellular phone or other electronic device which is capable of unique identification wirelessly.
A storage for the unique identification number and location.
A storage for the device's entry time.
A receiver for accepting notification of specific interest by the individual.
A storage for the device's exit time.
A detector for a future visitation of the device.
A computer to calculate a reward geared towards the specific interest.
A transmitter of the award.

7. The method of claim 1, wherein the reward is delivered based upon prior visitation, regardless prior purchase.

8. The method of claim 2, wherein the reward is delivered based upon prior visitation, regardless of prior purchase.
